(19) United States
(12) Patent Application Publication
(10) Pub. No.: US 2009/0021496 A1
(43) Pub. Date: Jan. 22, 2009

(54) Voltage Partitioned Display

(75) Inventor: Aris K. Silzars, Sammamish, WA (US)

Correspondence Address: SUTHERLAND ASBILL & BRENNAN LLP, 999 PEACHTREE STREET, N.E., ATLANTA, GA, 30309, US

(73) Assignee: NANOLUMENS ACQUISITION, INC., Norcross, GA (US)

(21) Appl. No.: 11/779,802

(22) Filed: Jul. 18, 2007

(51) Int. Cl. G06F 3/038

(52) U.S. Cl. 345/204

(57) ABSTRACT

A voltage partitioned display (VPD) is presented that provides a flexible uniformly bright large area display panel that is easily scalable. The VPD of the invention can be variously shaped and, due to its flexibility, can be rolled to facilitate packaging and shipping. The VPD can comprise a single substrate tile or a plurality of substrate tiles and may include display elements of a variety of display technologies such as, but not limited to electroluminescent displays, plasma displays, liquid crystal displays, etc. The substrate tile of the VPD is voltage partitioned into display subportions so that the display elements within each display subportion receive substantially the same scanning voltage, thereby producing a uniformly bright display. Vias can extend from a front substrate surface to a rear substrate surface to provide electrical connectivity between display elements on the front surface and drive circuitry on the rear surface of the substrate.

### FIELD OF INVENTION

In general, the present invention relates to electronic displays, and more particularly to large screen electronic displays,

### BACKGROUND

Electronic display technology has advanced rapidly. Originally employed in small electronic devices such as watches, calculators, and radios, electronic displays are now regularly used in desktop computers, laptop computers, televisions and home theater systems. Today progress continues to be made in both emissive displays such as LED, plasma, field emission and electroluminescent displays, as well as light valve displays such as LCDs. Display resolution has improved as pixel density has increased so that high definition displays are now available to the consumer. However, the amount of information available and the amount of information desired by a viewer continue to increase, creating a demand for larger display panels in order to display an increased amount of information. In addition, particular display applications may require large display panels to provide an optimum display. For example, applications in which a large number of viewers may desire to view the display, such as displays mounted in airports, shopping malls, arenas, sports stadiums, auditoriums, theaters, simulation and training facilities, and other commercial venues, may require large-sized displays. Apart from the commercial applications, private consumers often desire large screen television and home theater displays. Thus, despite the progress made to date, there remains a demand for large screen displays, particularly large flat panel displays. An additional desire exists for large flexible displays.

In the past, several problems have discouraged or prevented the production of a large display panel formed on a continuous substrate. One significant problem is that generally, as the size of the display increases, the production yield decreases. This problem has become more widespread as pixel densities have increased with the more recent pixel formats such as the VGA (640×840), SVGA (800×600), XGA (1024×768), and SXGA (1280×1024). As pixel density increases, the pixel complexity also tends to increase, as well as the circuitry required to address and drive the pixels. When attempts are made to increase the panel size with the increased pixel density, random material or particle defects can significantly lower the manufacturing yield. As the display panel size increases, the deleterious effects of thermal expansion, humidity, residual stresses and physical sag can also become more significant. Consequently, as a general rule, the cost of a prior art monolithic display increases exponentially with size. In addition, some size limitations can be imposed by the materials used in the manufacturing process. For example, displays employing glass substrates and/or seals can be limited in size because glass is rigid, relatively heavy and prone to fracture.

A further problem encountered in the manufacture and design of large scale passive matrix displays is the limitation imposed on the number of rows that can be addressed at one time or sequentially without adversely affecting the brightness of the display. As display panels are scaled to larger sizes, the number of lines to be addressed increases. However, the number of lines that can be passively addressed is constrained by the amount of dwell time available. Displays of 1000 lines or more cannot be passively addressed by illuminating one row at a time because there is not enough dwell time to do so and still produce an adequately bright display.

Another problem encountered in the scaling of electronic displays is the variation in brightness across the display panel. In general, display pixels are arranged in rows that extend across the length of the display and columns that extend along the height of the display to form an addressable matrix. In most matrix arrays, an electrode extending across a row of the display connects the pixels in a row to a row driver that provides a scanning voltage to the row of pixels. Similarly, a column electrode extending along a column of the display connects pixels in a column to a column driver circuit that provides a data voltage to the pixels in a particular column. In a passive matrix display, rows are provided a scanning voltage sequentially. When a pixel in a row receives a combined scanning and data voltage that exceeds a pixel threshold voltage, the pixel is illuminated. As the area of the display panel increases, the length of the row and column electrodes also increases. As the electrode length increases, the line resistance and capacitance encountered by the electrode as it extends across the display also increases, which can decrease the voltage provided to the pixels at the end of the row or column. For example, if the scanning voltage driver circuitry is located at the left side of a display panel, the pixels on the left side can appear brighter than the pixels on the right side of the display. Because disparities in brightness levels are distracting to a viewer, such displays are unacceptable to consumers. Thus there is a need for a large panel display that is uniformly bright.

U.S. Pat. No. 6,066,916 ('916) to Osada et al. teaches an electroluminescent matrix display device having connecting terminals for both scanning and data electrodes formed on one side of the display panel. The scanning electrodes are formed vertically on the panel so they can be connected directly to terminals formed on the bottom side of the display panel, and the data electrodes are formed horizontally to be connected to the terminals at the bottom side through wiring leads. Since the wiring leads have different lengths and resistances from one another, the resistances are compensated or adjusted by changing widths of the wiring leads or adding compensating resistors thereto so that the wiring resistances become uniform or differences thereof are reduced. Running directions of the scanning and data electrodes may be exchanged; in which case wiring resistance differences for the scanning electrodes are eliminated or reduced in a similar manner as done for the data electrodes. In the '916 patent Osada reduces luminance variances by providing compensating resistors for the row or column electrodes, which, although adequate for its intended purpose, increases circuit and contact density on the front of the display panel by placing all driver circuitry and terminals thereto on along the bottom portion of the display. When contact density is increased, the contacts may become too crowded to accommodate the tolerances available in connectors which are designed to connect the pads or contacts to the driving electronics. Short circuit problems may also occur.

U.S. Pat. No. 6,867,541 ('541) to Okuyama teaches an apparatus that alleviates some of the problems associated with electrode line resistance using transistor switching. This is accomplished by forming a contact of relatively large size in a region where two wide line portions, one drawn from a common electrode and one formed by gathered lines extending from a plurality of the common electrode terminals, overlap. An insulating film is interposed between the two wide line portions, and the cathode terminals and the cathode are connected through an intermediate layer composed of a conductive oxide material. The '541 patent teaches an active matrix EL display in which each pixel is switched on by a TFT. Although adequate for its intended purpose, the '541 patent decreases line resistance by providing wider electrode areas on the surface of the display. However as display resolution increases, it is desirable to minimize electrode widths to allow higher pixel density and maximize the amount of the display surface that is used as a display portion as opposed to an electronics portion. Thus there is a need for a wide panel display with uniform brightness over its width that increases the portion of the panel used to display images.

In lieu of creating a monolithic display, another approach to address the aforementioned problems associated with the manufacture of wide panel displays is to tile multiple display panels together to form a large tiled display. However, various problems can arise when panels are tiled together. In general, a tiled display is formed by joining a plurality of small-scale individual display panels. In most prior art tiled displays the drive circuits of each small-scale panel had to be positioned proximate to the display pixels in areas that did not interfere with the light emitted by the pixels and yet allowed adjacent panels to be joined. These constraints often led to a gap between the display portion of the panel and the edges of the panel. As a result, the seams between the adjoining small-scale panels were evident, distracting from the overall appearance of the resultant large screen display. Some particular display technologies, such as liquid crystal, vacuum fluorescent and plasma displays require front and rear sealing, often performed using glass, which further constrains and complicates the tiling process. For example, it is often difficult to effectively address pixels of the various panels; as a result, differences in drive characteristics across the tiled display can adversely affect the appearance of the display.

U.S. Pat. No. 5,585,695 ('695) to Kitai teaches a transparent thin film electroluminescent display module formed on a transparent substrate upon which a sequence of patterned thin layer is deposited and a patterned sealing layer and driver circuit(s) are applied. The absence of edge connections and a bulky edge seal permits production of a tiled display in which module-to-module spacing is not limited by connectors or seals so that multiple electroluminescent display modules may be tiled together edge-to-edge to form a large display panel. The Kitai patent teaches an EL module comprising a multitude of radiating display elements which may be electrically controlled with driver circuitry mounted directly on the rear of the module, thereby reducing the number of external connections necessary to operate the module. The '695 display features a light permeable substrate such as glass or plastic upon which a series of conducting insulating and radiating thin films which comprise an EL structure are deposited. The '695 display also provides an EL electronic driver chip mounted above the EL display elements on the back side of the substrate and connected with the EL connection pads.

The Kitai device attempts to solve the problems that occur at the edges of tiled panels by providing a tiled display in which the driver circuitry for each panel is placed above and over the EL radiating elements formed on the panel, as opposed to being placed at the sides of the panel substrate. Although adequate for facilitating the display tiling process, the Kitai display does not directly address the issue of uniform brightness across either a small-scale panel of the display, nor the resultant large-scale tiled display. Further, the placement of the drive circuitry on each individual panel of the display on the same side as the EL radiating elements increases circuit density on the display surface and may limit other physical aspects of a large-scale display that may be desirable, such as flexibility.

U.S. Pat. No. 6,262,696 ('696) to Seraphim teaches a flat panel display in which the interpixel spacing between two adjacent tiles maintains the uniformly periodic spacing of the interpixel spacing within tiles. The display is addressed as a single “monolithic” display, without reference to the plurality of individual tiles making up the display. All of the interconnections between tiles are located between tiles in the shadow area unless all tiles can have an edge around the periphery of the display. In a preferred embodiment, circuit lines providing the electrical connections for a tile are disposed on a single sheet of glass with insulation between the two layers and vias joining the bottom layer to a surface layer. The preferred embodiment comprises a glass back plate to which all the tile modules are connected and which contains a full length of interconnections in one direction joining all tiles. To increase display area so that pixels can be placed closer to the edges of the tiles in order to maintain interpixel spacing between tiles, column and row line interconnection lines are connected to edge connectors which are wrapped around an edge of the tile to the bottom of the tile or to a tile carrier and then are connected to lines on the back plate to interconnect the tiles.

While adequate for its intended purpose, the Seraphim display addresses the problem of aligning adjacent tiles to form a tiled display. The Seraphim display provides electrical connections by going around the edges of a display panel to reach the back of a panel. This requires that the seams between tiled panels accommodate the passage of electrical connections without adversely affecting interpixel spacing or overall display appearance. Furthermore, the use of glass as taught by the '696 patent makes the tiled display heavy and generally inflexible.

U.S. Pat. No. 6,897,855 ('855) to Matthies et al. also addresses the tiling of multiple display panels to form a large-scale display. The '855 patent teaches a tiled electronic display structure in which a tiled display device is formed from display tiles having picture element positions defined up to the edge of the tiles. Pixel driving circuitry is located on the back side of the tile and connections to pixel electrodes on the front side of the tile are made by vias which pass through portions of selected pixel areas which are not occupied by the active pixel material. The tiles are formed in two parts, an electronics section and a display section, and are electrically connected and physically joined to corresponding connecting pads on the electronics section to form a complete tile. Each connecting pad is electrically coupled to one row electrode or one column electrode at a plurality of respectively different locations. Each tile has a glass substrate on the front of the tile.

The Matthies patent teaches a device in which the electrical structure of a backpanel provides for the distribution of power and signals to the tiles and the electrical structure of the tiles provides for the addressing of the display pixels. The scan electronics can be internal to the tile and the scan rate of any one tile is the same for a small display or for a large display. This ensures that the brightness and the gray scale of the display do not degrade with increasing size. In general, the front-to-back connections include one for each row of pixels and one for each column of pixels on the tile. The tiled displays of Matthies have relatively few pixels so that the number of interconnects per tile is relatively small. Although adequate for its intended purpose, the Matthies display retains the conventional structure in which a row of interconnected pixel elements in a display panel is provided a voltage by a row electrode. Uniform brightness is achieved by reducing the number of pixels in a row by reducing the size of a display panel. However, by making each display panel very small, a large number of individual panels are required in order to form a large screen display. The larger the number of tiles required, the larger the number of tiling operations which must be performed to join them and the more processing that must be performed by a processor which provides control and synchronization signals for the voltage drivers for each individual panel. In addition, the Matthies patent teaches the use of a glass substrate on which the pixels are formed and through which the display is viewed. The use of a glass substrate may limit other desired display characteristics such as flexibility.

Flexible displays are often considered the “Holy Grail” of the display industry and offer many potential advantages over the rigid displays that have existed for the past 100 years; these advantages include thin profiles, reduced weight, ability to be rolled and conformed, high throughput manufacturing, increased mobility, and the ability to make displays in shapes other than the traditional rectangular screen, among others. The desire for flexible displays has grown from the development of portable electronics, where durability, lightweight and low cost displays are a premium. Currently, flexible displays have only been realized in simple electrophoretic monocolor displays on plastic used for in-store dynamic signage and the like. This desire has grown to include large scale displays. As consumer displays have grown in screen size, so has the size of enclosure. The past several years have seen the introduction of flat panel plasma and LCD displays which offer a thinner profile than comparably sized rear projection models. While these offer space saving qualities, they cannot match the thin profile of a flexible display. Aside from consumer displays, many other marketplaces are realizing the impact flexible displays could have. Application spaces for flexible displays include consumer electronics, automotive, dynamic signage, E-paper and E-books, and others,

There is a need for a uniformly bright large panel display. There is a further need for a flexible uniformly bright large panel display. There is also a need for a display in which circuit density is decreased on the display surface of a display panel to maximize the area that can be allocated to the display pixels. There is a further need for a tiled display panel in which variously sized display tiles can be joined together. There is a further need for a tiled display in which a large number of display tiles can be joined together without adversely affecting the physical characteristics of the resultant tiled large panel display. What is further needed is a large panel display that is cost-effective and economical to manufacture and operate.

### SUMMARY OF THE INVENTION

The methods and apparatus presented herein are directed to a Voltage Partitioned Display (VPD). In an exemplary embodiment, the VPD of the invention is a flexible display panel comprising a plurality of display subportions, each subportion receiving substantially the same scanning voltage to produce a uniformly bright display. In an exemplary embodiment of the VPD, each subportion contains at least one display element coupled to a display substrate; a plurality of subelectrodes, each adapted to deliver a voltage to a display subportion, and a voltage bus conductor electrically coupled to the subelectrodes and adapted to provide a voltage thereto from a voltage source. In an exemplary embodiment, the voltage bus conductor provides a scanning voltage to the subelectrode. The display subportions of the VPD receive substantially the same voltage from the voltage bus conductor, thereby forming a uniformly bright display panel.

In an exemplary embodiment, the subelectrodes are formed on a first opposing surface of the substrate, and the voltage bus conductor is formed on a second opposing surface of said substrate. For example, the subelectrodes can be formed on a front surface and the voltage bus conductor formed on a rear surface. The subelectrodes are connected to the voltage bus conductor through z-axis vias that extend from said first opposing surface through the display panel substrate to said second opposing surface. By providing the voltage bus on the rear surface of the substrate, the voltage bus, and connections thereto, can be adequately sized and positioned anywhere on the rear surface of the display without affecting pixel density or increasing circuit density on the front surface of the display. Likewise voltage drivers can be positioned anywhere on the rear surface.

In a first exemplary embodiment, the VPD is a display panel comprising an addressable matrix of display elements arranged in rows and columns on a continuous substrate to form a monolithic display. By convention, rows are defined as extending across the length of the display panel, and columns are defined as extending along the height of the display panel. However, the invention is not limited to such an arrangement. The VPD is partitioned into a plurality of display subportions, each connected to a voltage bus by a subelectrode. The display subportions and subelectrodes are designed so that each subportion receives approximately the same voltage from the voltage bus conductor. Accordingly, the voltage provided to the display elements within each subportion of the display is substantially the same, so that the display elements across the display can be uniformly bright. Thus, the prior art disparities between brightness levels of display elements on a first side of the display, say a left side, and those on a second side of the display, say a right side, are reduced or eliminated. Depending on the size of the display, a single voltage driver can be used as a voltage source for the monolithic display, or multiple voltage drivers can be used, with a controller providing timing, synchronization, and other control signals to coordinate the various voltage drivers. It is noted that the display subportions and subelectrodes need not be uniformly sized across the display panel in order to provide substantially the same voltages to each subportion.

In a second exemplary embodiment, the VPD comprises a plurality of display tiles joined together to form a tiled panel. The tiled VPD can comprise a plurality of display tiles in which the subelectrodes and the voltage bus conductor of each display tile are adapted to connect to a voltage driver for the display tile and thereby form an independently partitioned display tile. The independently partitioned display tiles can then be joined together to form a large scale display panel. Various means can be employed to join the tiles together. A controller can be provided to supply synchronization and control signals to coordinate the drive circuitry of each display tile. This embodiment offers the advantage of forming and testing a completed display tile prior to integration into a large scale display. A further advantage is the ability to replace a tile after it has been integrated into the large scale display. A tile that becomes damaged can be swapped out for a new tile so that the large scale display can still be used. Again, by using the rear surface for the drive circuitry, there is flexibility in the size and placement of the voltage bus conductor and connections thereto.

In a further exemplary embodiment of a tiled VPD, non-partitioned display tiles can be joined together to form a tiled panel, which can then be partitioned. For example, the display elements and portions of the subelectrodes, for example the subconductors on a front surface of the substrate, can be formed on a plurality of display tiles which are then joined together. After the tiles have been joined to form a large scale display panel, the tiled panel can be partitioned wherein the remaining portions of the subelectrodes, for example the subconductor connectors, and the voltage conductor bus can be formed. This embodiment allows a subportion and/or subelectrode to cover areas of multiple tiles. Similarly the voltage bus conductor may extend over multiple display tiles.

An exemplary method of the invention includes: providing a substrate; partitioning the substrate into a plurality of display subportions, providing display elements to said substrate, and providing voltage driver circuitry. An exemplary method of partitioning the substrate comprises providing a plurality of subelectrodes adapted to provide a voltage to the display subportions and providing a voltage bus conductor electrically coupled to the subelectrodes and adapted to deliver a voltage from a voltage source. An exemplary method of the invention can further include providing z-axis vias, extending from a first opposing surface of the substrate, through the substrate to a second opposing surface of the substrate, that are adapted to provide electrical connectivity between the first opposing surface of the substrate and the second opposing surface of the substrate. A further exemplary method of the invention can include providing a plurality of display tiles, forming a tiled panel by joining the display tiles, and integrating drive circuitry to the tiled panel to form a tiled display. Still a further method of the invention can include providing display tiles, joining the display tiles to form a tiled panel, partitioning the tiled panel and integrating drive circuitry.

In one aspect of the invention display elements and requisite drive circuitry are provided on a flexible substrate to form a flexible large-scale display. By using a flexible substrate, the limitations imposed by the use of a glass substrate are obviated. As the flexible substrate can be a lightweight substrate, display weight does not become a factor in scaling up the display size, and the substrate can be variously shaped, for example the substrate can be polygonal without being limited to the conventional four-sided shape of prior art displays. It may also have rounded or curved edges. The use of a thin flexible substrate allows a display panel or tile of the invention to be variously shaped in accordance with a particular application or a user's preference. Furthermore, the flexible substrate allows a large VPD to be rolled up for easy shipping and distribution and flexed around non-planar surfaces.

In a further aspect of the invention, a large scale uniformly bright display is formed on a single continuous substrate panel. By partitioning the panel into display subportions connected to a voltage bus by subelectrodes, voltage disparities across the display can be reduced or eliminated. When the voltage bus conductor is provided on the opposing substrate surface from the display elements, and connections between the subelectrodes and the voltage bus conductor are made through z-axis vias, circuit density is reduced on the display side, allowing greater pixel density and providing a high resolution display panel.

In a further aspect of the invention, an “infinitely” tileable display is formed by joining multiple display tiles together, as the previous physical size limitations imposed on prior art displays are avoided. By partitioning the display into display subportions connected to a voltage bus conductor by subelectrodes, a large scale display can be made to have uniform brightness throughout, regardless of the size of the display. A tiled VPD of the invention can include variously sized display tiles. For example a large display panel can be tiled to multiple smaller sized display tiles, so that a custom-sized display can be formed to suit the needs of a user.

In an exemplary embodiment, the display elements of the VPD are electroluminescent (EL) elements. However, the term display element as used herein can refer to emissive elements as well as light-valve elements; accordingly the teachings of the present invention can also be used to make other display types such as, but not limited to, plasma, field emission and LED display panels, as well as LCDs. When practiced as an EL display, the display elements can be formed as nixels, as discussed in U.S. patent application Ser. No. 11/526,661, which is hereby incorporated in its entirety by reference. Alternatively, the display elements can be formed as SSTFEL as taught by U,S. Patent Application Publication No. 200710069642, which is hereby incorporated in its entirety by reference, Additionally, the display elements can be in the form of those with single-sided electrical contacts, as disclosed in U.S. patent application Ser. No. 11/683,489 entitled Electroluminescent Nixels and Elements with Single-Sided Electrical Contacts, which is herein incorporated in its entirety by reference.

### BRIEF DESCRIPTION OF THE DRAWINGS

FIG. 1 shows a Voltage Partitioned Display (VPD) in accordance with an exemplary embodiment of the invention.

FIG. 2 shows a VPD in accordance with an exemplary embodiment of the invention.

FIG. 3A shows a front view of a VPD in accordance with an exemplary embodiment of the invention.

FIG. 3B shows a rear view of the VPD of FIG. 3A.

FIG. 4A shows a front view of a VPD in accordance with an exemplary embodiment of the invention.

FIG. 4B shows a rear view of the VPD of FIG. 4A.

FIG. 5A shows a flow diagram of a method in accordance with an exemplary embodiment of the invention.

FIG. 5B shows a flow diagram of a method in accordance with an exemplary embodiment of the invention.

FIG. 6A shows a VPD in accordance with an exemplary embodiment of the invention.

FIG. 6B shows a VPD in accordance with an exemplary embodiment of the invention.

FIG. 6C shows a VPD in accordance with an exemplary embodiment of the invention.

FIG. 7A shows a front surface of an exemplary embodiment of a tiled VPD of the present invention.

FIG. 7B shows a rear surface of the VPD of FIG. 7A.

FIG. 7C shows an exemplary embodiment of a tiled VPD of the present invention.

FIG. 8 shows a flow diagram of a method in accordance with an exemplary embodiment of the invention.

FIG. 9 shows an exemplary embodiment of a tiled VPD of the present invention

FIG. 10 depicts a flow diagram of an exemplary method of the invention.

FIG. 11A shows a front view of an exemplary embodiment of a VPD of the invention.

FIG. 11B shows a rear view of the VPD of FIG. 11A.

### DETAILED DESCRIPTION

As required, exemplary embodiments of the present invention are disclosed herein. These embodiments are intended to be examples of the various ways in which the present invention can be practiced, and it is understood that the invention may be embodied in alternative forms. The figures provided herein are not drawn to scale, and some features may be exaggerated or minimized to emphasize particular details, while related elements may be minimized or eliminated to avoid obscuring novel aspects of the invention. Specific functional and structural details disclosed herein are not intended to represent limitations; instead they are simply examples put forth to properly teach the invention and provide a representative basis for the claims. It is understood that alternative embodiments of the present invention will appear to those skilled in the art.

The methods and apparatus provided herein are directed to a Voltage Partitioned Display (VPD) which can provide a uniformly bright display throughout, regardless of its size. In a first exemplary embodiment, a VPD of the present invention can be a monolithic display panel formed on a continuous substrate. The VPD is voltage partitioned into a plurality of display subportions, with each display subportion provided a voltage by a subelectrode. The display subportions and subelectrodes are arranged so that display subportions across the VPD receive similar voltages, thereby providing a display panel with uniform brightness throughout. A voltage bus conductor adapted to deliver a voltage from a voltage source to the plurality of subelectrodes is provided. In an exemplary embodiment, the subelectrodes can be formed on a first surface, for example a front surface, of the display substrate, and the voltage bus conductor can be formed on a second surface of the display substrate, for example a rear surface. Electrical connectivity can be established between the two opposing surfaces by z-axis vias that extend from the front surface through the substrate to the rear surface. By providing the voltage bus conductor and connections thereto on the rear surface, the invention offers flexibility in the sizing and positioning of the voltage bus and connections, since components disposed on the rear surface do not encroach on the display area occupied by the display elements on the front surface.

In a further exemplary embodiment, a VPD of the invention comprises a plurality of display tiles joined together to form a tiled display panel. VPD display subportions can be defined to a single tile, or defined as including portions of multiple tiles. The display tiles used to form a tiled VPD can be variously sized; for example a large display tile can be joined to multiple smaller display tiles. Thus, a VPD can be economically custom-sized to suit a user's requirements. The display tiles used to form a tiled VPD can be tested prior to VPD integration in order to improve manufacturing yield. In addition, the display tiles can be joined in a manner that allows removal of a damaged or malfunctioning display tile and replacement with a new display tile. Although referred to herein as an emissive display comprising display elements, the VPD of the present invention can include displays such as, but not limited to, electroluminescent, plasma, and field emission displays, as well as light-valve displays such as liquid crystal displays (LCDs) and other current and future display technologies.

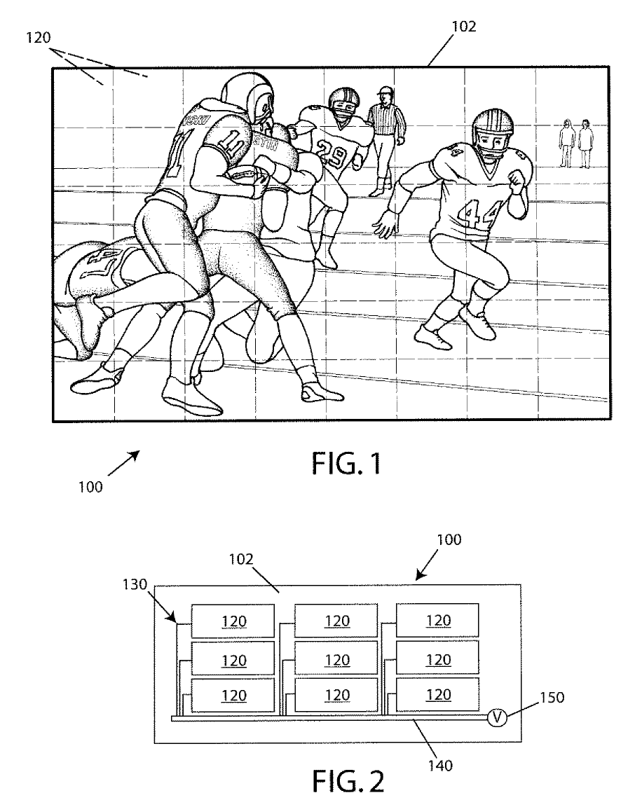

Turning to the figures, wherein like numerals represent like features throughout the views, FIG. 1 shows an exemplary embodiment 100 of a VPD of the present invention. Referring to FIG. 1, the VPD 100 comprises a continuous substrate 102, and a plurality of display subportions 120, each subportion 120 receiving a partitioned voltage from a voltage source (not shown). In an exemplary embodiment, the continuous substrate 102 is a flexible substrate. As shown in FIG. 2, the VPD 100 includes a plurality of subelectrodes 130, each adapted to deliver a voltage to at least one display subportion 120, and a voltage bus 140 electrically coupled to the subelectrodes 130 and adapted to provide a voltage thereto from a voltage source 150. The display subportion 120 and subelectrode 130 can be defined so that the line resistance and capacitance encountered by the subelectrode 130 does not significantly affect the voltage delivered to the subportion 120. As a result, each subportion 120 of the VPD 100 can receive approximately the same voltage so that the VPD 100 can provide a uniformly bright display. Thus the VPD 100 forms a voltage partitioned display of uniform brightness. It is noted that although the subportions 120 are shown as equivalent in size, it is contemplated that subportions 120 and subelectrodes 130 may vary in size, in which case the variably sized subportions 120 across the VPD 100 can still be provided with substantially the same voltage,

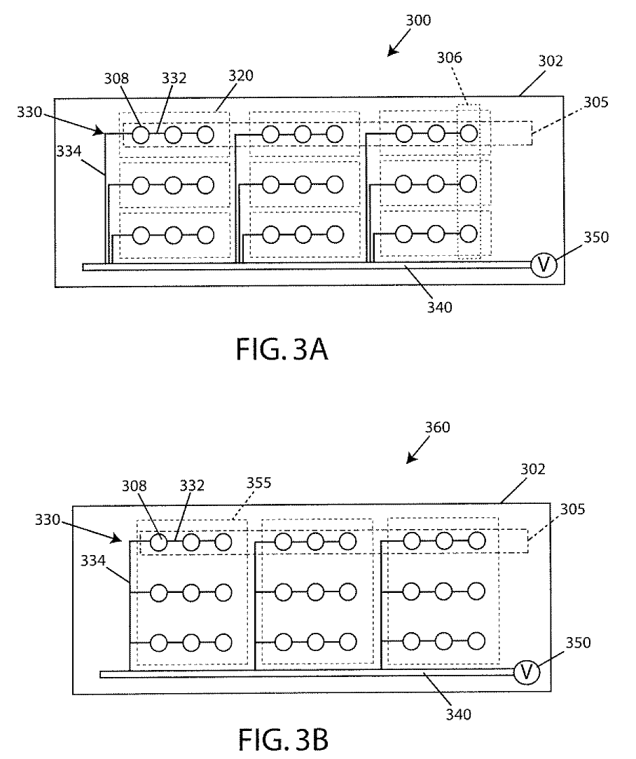

FIG. 3A provides an illustration of a VPD 300 of the invention. Referring to FIG. 3A, the VPD 300 comprises a plurality of display elements 308 arranged in an addressable matrix of orthogonal rows 305 and columns 306. However it is contemplated that other arrangements of display elements 308 can also be employed. Further, as discussed herein for teaching purposes, the rows 305 are defined to run horizontally across the length of the VPD 300, and the columns 306 defined to run along the height of the VPD 300. However it is contemplated that rows and columns could be otherwise defined.

As mentioned previously, a VPD of the invention is partitioned into a plurality of display subportions 120 adapted to receive substantially the same voltage, thereby reducing or eliminating luminosity differences across the display. As shown in FIG. 3A a subportion 320 is defined as a portion of a row 305 of display elements 308; however the subportion 320 may be alternatively defined. For example, a VPD 360 may contain a subportion 355 defined as containing portions of a plurality of rows 305 as shown in FIG. 3B. As shown in the exemplary embodiment 300 depicted in FIG. 3A, the subelectrode 330 can comprise two parts; a subconductor 332 that interconnects the display elements 308 contained within the subportion 320, and a subconductor connector 334 which connects the subconductor 332 with the voltage bus conductor 340. The subelectrode 330 can comprise a subconductor 332 and subconductor connector 334 that are joined at their intersection; or may comprise a continuous element that extends from the voltage bus conductor 340 to the display elements 308 contained within the subportion 320.

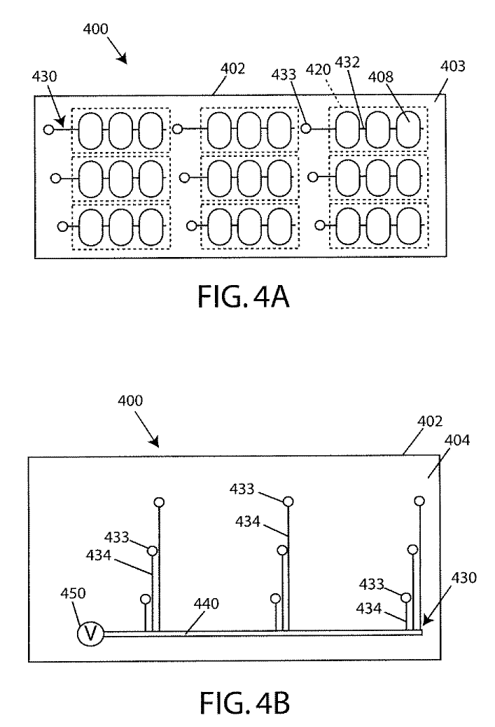

FIGS. 4A and 4B show an exemplary embodiment 400 of a VPD of the invention in which a plurality of display elements 408 are formed on a front surface 403 of a substrate 402, and a voltage bus conductor 440 is formed on a rear surface 404 of the substrate 402, As shown in FIG. 4A, the VPD 400 is partitioned into a plurality of display subportions 420, each containing a plurality of display elements 408 and coupled to a subelectrode 430 which comprises a subconductor 432 and subconductor connector 434. Vias 433 are provided to allow electrical connectivity between the front surface 403 of the substrate 402 and the rear surface 404 of the substrate 402. The subconductor 432 on the front surface 403 of the substrate 402 is electrically connected to a subconductor connector 434 on the rear surface 404 through the via 433 to complete the subelectrode 430. FIG. 4B shows the rear surface 404 of the substrate 402 of the VPD 400. As shown in FIG. 4B, the subconductor connector 434 can extend from each via 433 to the voltage bus conductor 440 which provides connectivity with a voltage source 450. A subconductor connector 434 can be electrically connected to more than one subconductor 432.

Referring to FIG. 4A, in an exemplary embodiment, the substrate 402 is a flexible substrate. For example, the substrate 402 can comprise a thin polymer film such as polypropylene, polyester, or Kapton®. Alternatively the substrate 402 can comprise other polymers or a plastic sheet. By using a flexible material for the substrate 402, a flexible VPD can be formed that is rugged yet lightweight; allowing a VPD of the invention to avoid the size limitations imposed by heavy substrate materials such as glass that were used in the prior art. In addition, the use of a flexible material such as a thin polymer film allows high yield manufacturing techniques such as roll-to-roll processing to be employed in the manufacture of the VPD 400. Furthermore, the use of a lightweight flexible material for the substrate 402 facilitates the distribution and installation of the VPD 400 as it can easily be rolled up, transported in a tube or carton, then unrolled and mounted on a wall.

The substrate 402 is partitioned into a plurality of display subportions 420 adapted to receive a voltage from a subelectrode 430, which comprises the subconductor connector 434 and one or more subconductors 432 to which it is electrically coupled. To optimize display performance, it is desirable that the display subportions 420 and the subelectrodes 430 be defined so that the voltage delivered to a first display subportion 420 by a first subelectrode 430 is substantially the same as that delivered to a second subportion 420 by a second subelectrode 430. The via 433 can provide electrical connectivity between the front 403 and rear 404 surfaces of the substrate 402. In an exemplary embodiment, the subelectrode 430 provides a scanning voltage to the display subportion 420. Discrepancies in scanning voltage led to many of the previously discussed uniformity problems associated with prior art displays. By voltage partitioning the VPD 400 into display subportions 420 that receive substantially the same scanning voltage, uniformity problems of the prior art can be avoided. In a preferred embodiment, the subelectrode 430 comprises a subconductor 432 disposed on the front surface 403 and a subconductor connector 434 disposed on the rear surface 404. The subelectrode 430 can be fabricated using a metallic substance, such as aluminum, rather than a transparent conductive film such as ITO, which has a much higher resistance. The use of a lower resistance material further improves the VPD 400 performance by reducing resistance losses over its width.

The display elements 408 can form pixels or subpixels for the VPD 400. In the VPD 400, the display elements 408 are arranged in orthogonal rows and columns to form an addressable array on the front surface 403 of the substrate 402. As mentioned previously, in the context herein the display elements 408 can encompass a variety of pixel or subpixel producing elements that can be used to produce a variety of display types including, but not limited to electroluminescent displays, plasma displays, field emission displays, and liquid crystal displays. In an exemplary embodiment, the display elements 408 comprise electroluminescent elements that radiate light when a sufficiently high voltage is applied. In a first exemplary embodiment the display elements 408 are in the form of a nixel as taught by U.S. patent application Ser. No. 11/526,661 entitled Electroluminescent Apparatus and Display Incorporating Same and incorporated herein in its entirety by reference. A display element 408 in the form of a nixel can comprise an individually sized and shaped EL apparatus that includes a ceramic substrate, a first charge injection layer on an upper surface of the ceramic substrate, a phosphor layer on top of the first charge injection layer a second charge injection layer on top of the phosphor layer, an upper electrode on the upper surface of the second charge injection layer, and a lower electrode on the lower surface of the ceramic substrate. In a further exemplary embodiment, the display elements are in the form of an SSTFEL as taught by U.S. Patent Application Publication No. 2007/0069642 entitled Sphere Supported Thin Film Phosphor Electroluminescent Device, which is herein incorporated in its entirety by reference. In an additional embodiment, the display elements may be in the form of a nixel, SSTFEL, or other emissive element utilizing single-sided contacts as taught by U.S. patent application Ser. No. 11/683,489 entitled Electroluminescent Nixels and Elements with Single-Sided Electrical Contacts, which is herein incorporated in its entirety by reference.

Referring to FIG. 4B, the voltage bus conductor 440 can be disposed on the rear surface 404 of the substrate 402. In a preferred embodiment, the voltage bus conductor 440 comprises a metallic substance such as aluminum. The voltage bus conductor 440 is electrically connected to the voltage source 450 which can provide a drive voltage for the VPD 400. In an exemplary embodiment, the voltage source 450 provides an ac scanning voltage of around 250V to the VPD 400. The voltage source 450 can be placed along the perimeter of the substrate 402 to maximize the flexibility of the VPD 400. Alternatively, the voltage source 450 can be placed anywhere on the rear surface 404 of the substrate 402 and adapted to provide a voltage to the voltage bus conductor 440.

In a preferred embodiment, the subconductor connectors 434, preferably comprising a metallic substance such as aluminum, are provided on the rear surface 404 of the substrate 402, and are electrically coupled to the voltage bus conductor 440. As shown in FIG. 4B, the voltage bus conductor 440 is coupled to a plurality of subconductor connectors 434, each of which extends to at least one via 433. The via 433 provides electrical connectivity between the subconductor connector 434 and the subconductor 432 which together form the subelectrode 430 that provides a voltage to the subportion 420. The via 433 can comprise, by way of example and not limitation, a conductive material such as a solder, a conductive paste, a conductive ink, a metallic substance, or other like material which can provide electrical connectivity. Thus, the subelectrode 430, comprising the subconductor 432 and the subconductor connector 434, can deliver a voltage to the subportion 420 from the voltage source 450 via the voltage bus conductor 440. The subportion 420, the subconductor 432, the subconductor connector 434 and the voltage bus conductor 440 are apportioned so that each subportion 420 receives substantially the same voltage from the voltage source 450, in order to form a uniformly bright display. One or more voltage sources 450 can be used to drive the VPD 400. In an exemplary embodiment the voltage source 450 provides a scanning voltage.

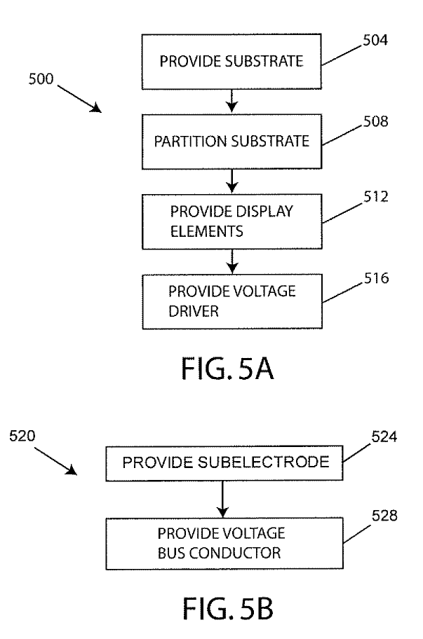

FIG. 5A shows an exemplary method 500 of the invention. The display substrate 402 can be provided at block 504. As discussed earlier, in an exemplary embodiment a flexible material such as a thin polymer film can be provided as a substrate so that a flexible VPD can be produced. At block 508, the display substrate 402 can be voltage partitioned.

FIG. 5B shows an exemplary method 520 for partitioning a display substrate. At block 524, a plurality of subelectrodes 430 can be provided to the display substrate 402. The subelectrode 430 is adapted to provide a voltage to a subportion 420. The subelectrode 430 can comprise the subconductor 432 on a front surface 403 of the display substrate 402 and the subconductor connector 434 on a rear surface 404 of the display substrate 402. The subconductor 432 and the subconductor connector 434 can be electrically coupled by the z-axis via 433. In an exemplary embodiment, the vias 433 can be formed by first using a drill or punch tool to penetrate the substrate 402 to form a hole, and then filling the hole with a conductive substance. On the front surface 403 of the substrate 402, subconductors 432 can be formed. The subconductors 432 can comprise thin film conductors, preferably metallic, that can be formed by a variety of processes known in the art, such as plating, evaporation, sputtering printing, or laminating. The subconductor 432 can be formed so that it is electrically coupled to the via 433 and adapted to provide a voltage to a subportion 420 of the display substrate 402. On the rear surface 404 of the display substrate 402, a plurality of subconductor connectors 434 can be formed by the techniques suggested above for the formation of the subconductors 432. In a preferred embodiment, the subconductor connectors comprise a metallic substance such as aluminum. The subconductor connectors 434 are electrically coupled to the vias 433 so that electrical connectivity can be established between the subconductors 432 and the subconductor connectors 434. A subconductor connector 434 can be electrically coupled to more than 1 via 433 in accordance with a desired subportion and subeletrode design.

At block 528 a voltage bus conductor 440 can be provided. The voltage bus conductor 440 is appropriately sized and positioned so that it can connect to a plurality of subconductor connectors 434. In an exemplary embodiment, the voltage bus conductor 440 comprises a metallic substance and can be formed by using one of the many techniques known in the art, such as, but not limited to, plating, sputtering, printing, laminating, or evaporation.

Referring back to FIG. 5A, after partitioning of the substrate, at block 512 the display elements 408 can be provided to the front surface 403 of the substrate 402. The display elements 408 can be embodied in a variety of forms as discussed previously herein. In an exemplary embodiment, the display element 408 is in the form of a nixel, and can be coupled to the subconductor 432 in a predetermined location so that the display element 408 can properly function as a pixel or subpixel of the VPD 400. For example, the nixel can be coupled to the subconductor 432, by soldering or other methods taught by the earlier referenced U.S. patent application Ser. No. 11/526,661, so that the bottom electrode of each nixel is electrically coupled to the subconductor 432. At block 516, voltage drivers and driver circuitry can be provided. The voltage source 450 can be coupled to the voltage bus conductor 440 and adapted to deliver a scanning voltage to the display subportions 420.

In an exemplary embodiment of the invention, the display elements 408 are electroluminescent elements arranged in a passive matrix array that receive both a scanning voltage and a data voltage. When the combined voltage applied to a display element 408 exceeds a threshold voltage, the display element 408 radiates light; otherwise the display element 408 remains dark. A common scanning voltage is applied to all the display elements 408, but the data voltage applied to each display element 408 varies in accordance with the image to be displayed.

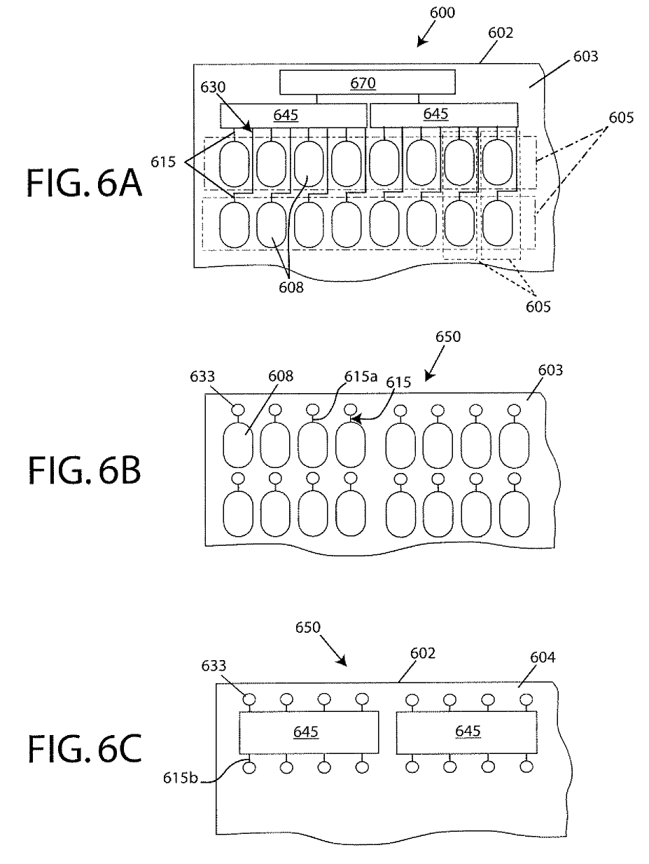

In a first exemplary embodiment, a data voltage is supplied by a data voltage driver that is electrically coupled to a plurality of display elements. FIG. 6A shows an exemplary embodiment 600 of a VPD of the invention. The VPD 600 includes a plurality of display elements 608 coupled to a front surface 603 of a substrate 602. A data voltage driver 645 is used to supply a data voltage to the display elements 608 in columns 605.

In an exemplary embodiment, the display element 608 is in the form of a nixel that includes a top electrode layer, preferably formed from a transparent conducting material such as ITO. A transparent insulating layer can be deposited on the front surface 603 of the substrate 602 in such a manner that the top electrode layers of the display elements 608 are left exposed. Leads 615 can be formed over the insulating layer to extend from the top electrode of each display element 608 to a pad (not shown) which provides electrical connectivity between the lead 615 and a pin of the data voltage driver 645. In an exemplary embodiment, the leads 615 are formed from a transparent conductive material such as ITO. The leads 615 are disposed so as not to interfere with the interpixel spacing on the VPD 600, and the deposited insulating layer prevents contact between the leads 615 and the row subelectrodes 630.

In an alternative exemplary embodiment, the display elements may be in the form of a nixel with single-sided contacts, in which the row and column electrodes of the display element are both disposed on the same side of the element, preferably the non-emitting side. These electrodes are electrically separated by a small gap or other insulating material. The element may be directly physically and electrically connected to the substrate, with row or column electrodes connected to the vias to the rear surface of the substrate.

The data voltage driver 645 is adapted to apply a data voltage to the display elements 608 in synchronization with other data voltage drivers 645 and voltage sources 650 (not shown) that may be employed by the VPD 600. A controller 670 may be used to provide synchronization and control signals to a plurality of data voltage drivers 645 and voltage sources. Placement of the voltage drivers 645, the scanning voltage sources, and the controller 670 around the periphery of substrate 602 can improve the overall flexibility of the VPD 600. As shown in FIG. 6A, in an exemplary embodiment, the data voltage driver 645 is electrically coupled to a plurality of display elements 608 disposed in separate rows 605. In this manner a plurality of rows 605 can be illuminated simultaneously when both a data voltage and a scanning voltage are provided.

FIGS. 6B and 6C show a further exemplary embodiment 650 in which z-axis vias 633 are provided proximate to each display element 608. The lead 615 can extend from a top electrode, or alternatively from an electrode on the non-emissive side of the display element in the case of single-sided contacts, of the display element 608 through the z-axis via 633 to pads disposed on a rear surface 604 of a substrate 602. In this embodiment, a portion 615b of the lead 615 extending from the voltage chip pad is disposed on the rear surface 604 of the substrate 602 (FIG. 6C). Because it is disposed on the rear surface 604, the portion 615b need not be transparent, and can comprise a metallic substance such as aluminum that has a lower resistance than ITO. In this configuration, the data voltage driver 645 can be placed along the perimeter of the substrate 602, or any where on the rear surface 604 of the substrate 602. A portion 615a of the lead 615 is disposed at the front surface 603 of the substrate extending from the top electrode of the display element 608 to the via 633. Lead portion 615a may be transparent or opaque and can comprise a substantially transparent conductor or a thin metallic wire that does not interfere with light emission from the display at normal viewing distance. Other conductors may be used.

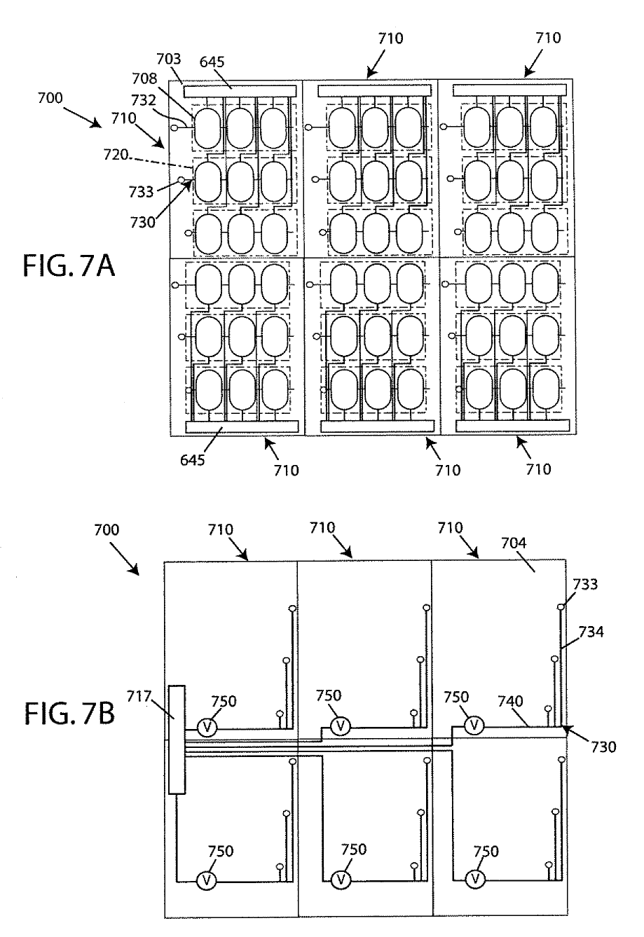

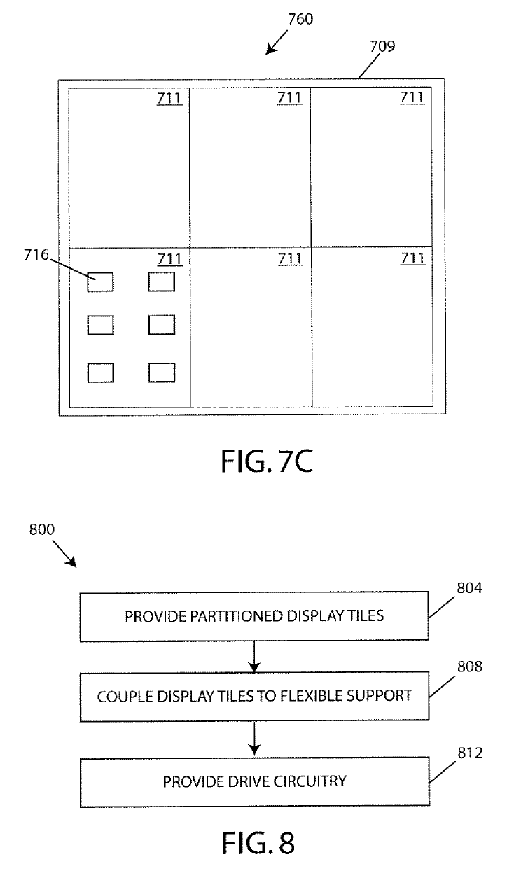

In a further exemplary embodiment 700, the VPD is in the form of a tiled display. Referring to FIG.7A, the VPD 700 comprises a plurality of display tiles 710. The display tiles 710 are joined together so that seams between the display tiles 710 fall within the display element 708 pitch so as not to be apparent to a viewer. The VPD 700 is voltage partitioned to include a plurality of display subportions 720, a plurality of subelectrodes 730, which comprise a subconductor 732 and a subconductor connector 734, at least one voltage bus conductor 740 and at least one voltage source 750. As shown in FIG. 7B, the subconductor connectors 734 and voltage bus conductor 740 can be disposed on a rear surface 704 of the VPD 700 and electrically coupled to the front surface 703 by vias 733. A controller 717 can be used to provide synchronization signals to the voltage sources 750 to coordinate synchronous operation of the display 700.

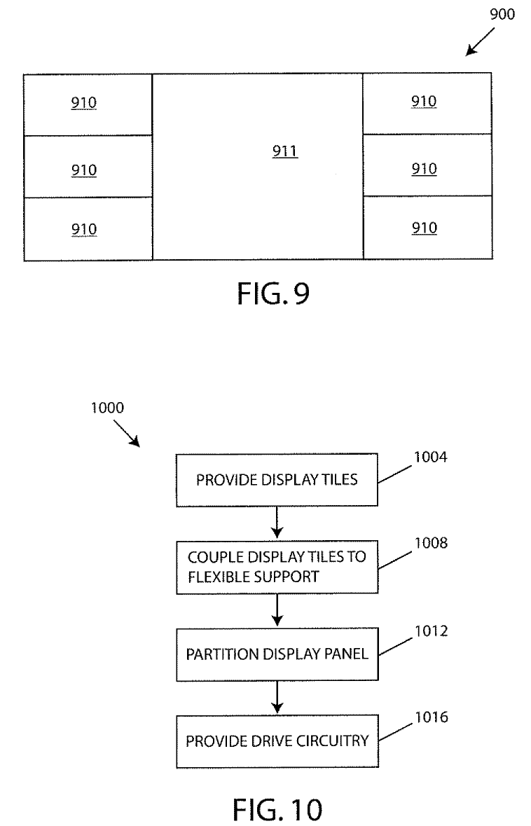

An exemplary method 800 of the invention for providing a tiled display 700 is depicted by the flow diagram of FIG. 8. At block 804 a plurality of partitioned display tiles 710 can be provided. In a first embodiment, the display tiles 710 are partitioned prior to integration into the VPD 700. This allows the operation and performance of each display tile 710 to be tested prior to joining the display tiles 710 to form a tiled panel, so that manufacturing yield can be increased. A partitioned display tile 710 can comprise subportions 720, subelectrodes 730 and at least one voltage bus 740. A partitioned display tile 710 may also include a data voltage driver 645 and/or a voltage source 750. The display tiles 710 shown in FIG. 7 are uniformly sized. However, as shown in FIG. 9, display tiles 910 and 911, which vary in size can be provided at block 804 and joined to form a tiled VPD 900. At block 808, the plurality of display tiles 710 can be coupled to a flexible support to form a tiled display. In an exemplary embodiment 760 as shown in FIG. 7C, a support 709 is provided which has a plurality of spaced-apart recesses 711 that are adapted to receive the display tiles 710. In an exemplary embodiment, the support 709 is a flexible support comprising a polymer sheet. To assist in the retention of the display tiles 710 to the flexible support 709 an adhesive 716 may be provided to the display tiles 710 or to the support 709. For example, silicone may be used. The recesses 711 are spaced so that adjacent display tiles 710 can be positioned in a manner that maintains the spacing between display elements 708 across the display 700. The use of a flexible support 709 allows the tiled VPD 700 to be a large panel flexible display. At block 812 data voltage drivers and circuitry can be provided if not previously provided on the partitioned display tile 710. A controller 717, and connections thereto can be provided to the VPD 700 as shown in FIG. 7B. The controller 717 can be adapted to coordinate the scanning and data voltages applied by the one or more data voltage drivers that provide a data voltage and voltage sources 750 that provide a scanning voltage, so that the proper display elements 708 can be illuminated to form a desired image. In a preferred embodiment, the flexible support 709 can receive the display tiles 710 face down so that a controller 717, and connections thereto, can be provided on a rear surface of a display tile 710.

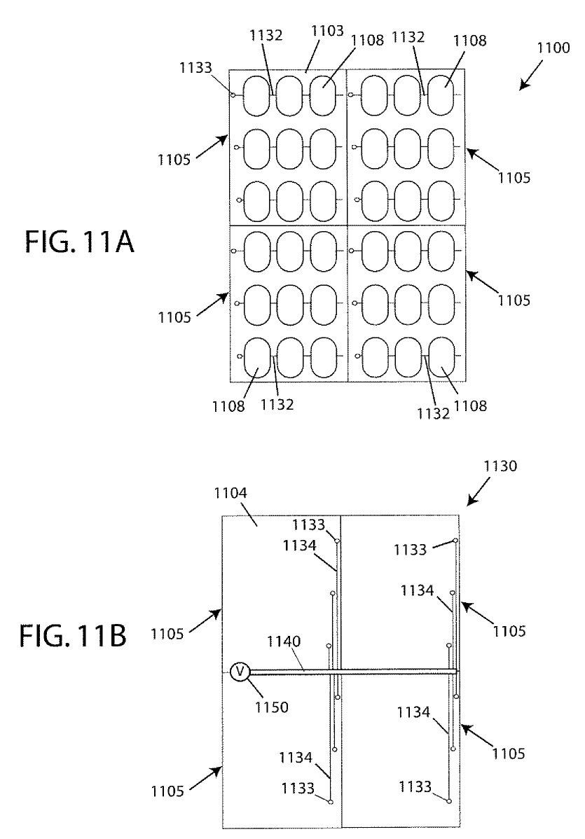

FIG. 10 shows a further exemplary method 1000 of the invention. Referring to FIGS. 10, 11A, and 11B, at block 1004 a plurality of display tiles 1105 are provided. The display tiles 1105 need not be uniformly sized. In this embodiment, the display tiles 1105 can include a plurality of display elements 1108 on a front surface 1103 of the display tile substrate. The display elements 1108 can be coupled to a subconductor 1132. The display tiles 1105 may also comprise vias 1133 that provide electrical connectivity between the front 1103 and rear 1102 surfaces of the display tiles 1105. At block 1008 the display tiles can be provided to a flexible support as discussed above to form a tiled display panel. At block 1012, the tiled panel can be partitioned into subportions that can receive substantially the same voltage from a voltage source 1150. One or more voltage bus conductors 1140 can be provided to the rear surface of the tiled panel. A plurality of subconductor connectors 1134 can be provided on the rear surface adapted to connect with the voltage bus conductor 1140. The subconductor connectors 1134 can connect with the subconductors 1132 on the front surface through the vias 1133 to form completed subelectrodes. The subconductors 1132, subconductor connectors 1134, and voltage bus conductor 1140 can be sized and positioned so that subportions 1130 across the VPD 1100 can receive substantially the same voltage from the voltage source 1150 At block 1016, data voltage drivers and scanning voltage sources can be provided on a rear surface 1104 as well as connections thereto. A controller can be provided to provide timing, synchronization and other control signals to the various voltage drivers and sources.

Because the drive circuitry can be placed on a rear surface 1104 of the VPD 1100, there is flexibility in the sizing and arrangement of the voltage bus conductor 1140 and the subconductor connectors 1134. Thus the voltage bus conductor 1140 can be made sufficiently wide and long to connect with a plurality of subconductor connectors 1134 without experiencing significant losses.

Thus the present invention provides methods and apparatus for a voltage partitioned display panel that includes a plurality of display subportions that receive substantially the same voltage, thus providing a uniformly bright display panel. In an exemplary embodiment, a flexible substrate is used. The flexible VPD of the invention can be variously shaped, easily transported, and flexed around non-planar surfaces. The use of z-axis vias allows display elements on a front surface of a substrate to electrically connect with drive circuitry located on a rear surface of the substrate, thereby allowing drive circuitry to be placed anywhere on the rear surface of the substrate, decreasing the electrical circuit density of the front surface, and allowing increased pixel density on the front surface. By partitioning the drive circuitry, very large-scale display panels can be formed while maintaining a desired brightness level,

Exemplary embodiments have been provided herein; however it is noted that the invention can be practiced in other ways that will occur to those skilled in the art. Accordingly, the invention is not limited to the examples presented herein, but is given the broadest scope defined by the following claims.

What is claimed is:

1. A voltage partitioned display comprising:
at least one display element;
at least one flexible substrate tile having a top surface and a bottom surface opposite the top surface, wherein the at least one display element is positioned adjacent to the top surface of the at least one flexible substrate tile;
at least one voltage drive circuitry positioned adjacent to the bottom surface of the at least one flexible substrate tile;
at least one via formed in the at least one flexible substrate tile that electrically connects the at least one display element and the at least one voltage drive circuitry.

2. The voltage partitioned display of claim 1, wherein the at least one display element is coupled to each of the at least one flexible substrate tile.

3. The voltage partitioned display of claim 1, wherein the at least one display element is one of an electroluminescent display element, a field effect display element, a plasma display element, and a liquid crystal display element.

4. The voltage partitioned display of claim 1, wherein the at least one flexible substrate tile is polygonal in shape.

5. The voltage partitioned display of claim 1, wherein at least one side of the at least one flexible substrate tile is curved.

6. The voltage partitioned display of claim 1, comprising at least two flexible substrate tiles.

7. The voltage partitioned display of claim 6, wherein the at least two flexible substrate tiles are physically coupled together.

8. The voltage partitioned display of claim 1, wherein the voltage drive circuitry includes at least one scanning voltage driver and at least one data voltage driver.

9. The voltage partitioned display of claim 8, wherein each scanning voltage driver and each data voltage driver is adapted to provide a voltage to at least one display element of a single substrate tile.

10. The voltage partitioned display of claim 8, wherein at least one of the data voltage driver and the scanning voltage driver is adapted to provide a voltage to at least one display element of a first flexible substrate tile and to at least one display element of a second flexible substrate tile.

11. The voltage partitioned display of claim 8, wherein both the data voltage driver and the scanning voltage driver are adapted to provide a voltage to at least one display element of a first flexible substrate tile and to at least one display element of a second flexible substrate tile.

12. The voltage partitioned display of claim 2, wherein at least a first display element coupled to a first substrate tile and at least a second display element coupled to a second substrate tile are electrically connected to a common electrode.

13. A method of providing a partitioned display, comprising,
providing at least one flexible display substrate;
partitioning the display substrate into at least one display subportion;
coupling at least one display element to each display subportion; and
providing voltage driver circuitry for the substrate, wherein the voltage driver circuitry is electrically connected to the at least one display subportion.

14. The method of claim 13, wherein partitioning the display substrate comprises,
providing at least one subelectrode for each display subportion of the display substrate; and
providing a voltage bus conductor for the display substrate, wherein the voltage bus conductor is electrically coupled to at least one subelectrode and the voltage driver circuitry.

15. The method of claim 14, wherein the at least one subelectrode is provided on a top surface of the display substrate, the voltage bus conductor is provided on a bottom surface of the display substrate opposite the top surface, and wherein partitioning the display substrate further comprises:
providing at least one via that electrically connects the at least one subelectrode and the voltage bus conductor.

16. The method of claim 13, wherein providing voltage driver circuitry includes providing one or both of (i) at least one scanning voltage means and (ii) at least one data voltage means.

17. A method of driving a large-area tiled display comprising:
providing at least one display tile comprising a plurality display elements arranged in a matrix of a plurality of rows and columns;
electrically connecting each row of display elements for each display tile with at least one subconductor;
passively addressing at least two rows of display elements simultaneously by providing a voltage to the at least one subconductor for each of the at least two rows of display elements.

18. The method of claim 17, wherein passively addressing at least two rows comprises simultaneously passively addressing one of (i) at least two rows of display elements for the same display tile and (ii) at least two rows on a first display tile and at least two rows on a second display tile.

19. The method of claim 17, wherein the at least one subconductor comprises a first subconductor provided on a top surface of each display tile, a second subconductor provided on a bottom surface of each display tile opposite the top surface, and at least one via through each display tile that electrically connects the first subconductor and the second subconductor.

20. The method of claim 19, further comprising:
providing voltage driver circuitry that provides the voltage to each second subconductor.
